(19) United States
(12) Patent Application Publication
(10) Pub. No.: US 2026/0125103 A1
(43) Pub. Date: May 7, 2026

(54) DEAD-TIME COMPENSATION FOR BRUSHLESS DC MOTOR CONTROL

(71) Applicant: Steering Solutions IP Holding Corporation, Saginaw, MI (US)

(72) Inventors: Taibin Wang, Suzhou (CN); Mengnan Zuo, Suzhou (CN); Yongfei Liu, Shijazhuang City (CN); Fei Lu, Suzhou (CN)

(21) Appl. No.: 18/950,943

(22) Filed: Nov. 18, 2024

(30) Foreign Application Priority Data
Nov. 7, 2024 (CN) 202411585410.7

(51) Int. Cl. B62D 5/04; H02P 6/10

(52) U.S. Cl. CPC B62D 5/046; H02P 6/10

(57) ABSTRACT

A method of operating an inverter for a brushless direct current (BLDC) motor includes: driving a high-side switch to conduct current between a DC high node and an output node connected to the BLDC motor and for a conductive period in each of a plurality of operating periods; driving a low-side switch to a conductive state after a dead-time after the conductive period and to conduct current between the output node and a DC low node; receiving a duty cycle command; determining an adjusted duty cycle representing the conductive period as a portion of an operating period; determining a duty cycle difference signal as a difference between an initial duty cycle based on the duty cycle command, and the adjusted duty cycle; and determining a feedback duty offset signal based on the duty cycle difference signal. The adjusted duty cycle is computed based on the feedback duty offset signal.

### CROSS-REFERENCE TO RELATED APPLICATION

This patent application claims priority to CN patent application No. 202411585410.7, filed Nov. 8, 2024, which is incorporated herein by reference in its entirety.

### TECHNICAL FIELD

This disclosure relates to control techniques for driving a brushless DC (BLDC) motor. More specifically, the present disclosure relates to control techniques to compensate of effects of dead-time in drivers for BLDC motors.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Brushless DC (BLDC) motors have a variety of applications. One such application is for providing a steering torque in an EPS system or a SbW steering system.

An inverter may be used to conduct current from a direct current (DC) supply to a winding of a BLDC motor by selectively conducting current between either of a DC positive node or a DC negative node to an output node. A dead-time may be used to prevent short circuiting that could otherwise result from both the DC positive node and the DC negative node being simultaneously connected to the output node. However, such dead-time can introduce undesirable effects, such as non-linear operation that can adversely impact control of BLDC motors.

### SUMMARY

An aspect of the disclosed embodiments includes a method of operating an inverter for a brushless direct current (BLDC) motor. The method includes: driving a high-side switch to a conductive state to selectively conduct current between a DC high node and an output node connected to the BLDC motor and for a conductive period in each of a plurality of operating periods; driving a low-side switch to a conductive state after a dead-time after the conductive period to selectively conduct current between the output node and a DC low node, wherein the DC low node and the DC high node have a DC voltage applied therebetween; receiving a duty cycle command; determining an adjusted duty cycle representing the conductive period as a portion of an operating period of the plurality of operating periods; determining a duty cycle difference signal as a difference between an initial duty cycle and the adjusted duty cycle, wherein the initial duty cycle is based on the duty cycle command; and determining a feedback duty offset signal based on the duty cycle difference signal. Determining the adjusted duty cycle includes computing the adjusted duty cycle based on the feedback duty offset signal.

Another aspect of the disclosed embodiments includes a method of operating an inverter for a brushless direct current (BLDC) motor. The method includes: driving a high-side switch to a conductive state to selectively conduct current between a DC high node and an output node connected to the BLDC motor and for a conductive period in each of a plurality of operating periods; driving a low-side switch to a conductive state after a dead-time after the conductive period to selectively conduct current between the output node and a DC low node, wherein the DC low node and the DC high node have a DC voltage applied therebetween; receiving a duty cycle command; determining a current between the output node and the BLDC motor; determining a prefeed duty offset signal based on the current between the output node and the BLDC motor; determining an adjusted duty cycle based on the prefeed duty offset signal and the duty cycle command; and determining the conductive period based on the adjusted duty cycle and a duration of an operating period of the plurality of operating periods.

Another aspect of the disclosed embodiments includes a system for operating a brushless direct current (BLDC) motor. The system for operating the BLDC motor includes: a DC power supply including a DC high node and a DC low node, wherein the DC low node and the DC high node have a DC voltage therebetween; an inverter having a phase driver configured to apply a DC power to the BLDC motor via an output node connected to the BLDC motor; and a controller. The phase driver includes: a high-side switch configured to selectively conduct current between the DC high node and the output node, and a low-side switch configured to selectively conduct current between the output node and the DC low node. The controller is configured to: drive the high-side switch to a conductive state for a conductive period in each of a plurality of operating periods; drive the low-side switch to a conductive state after a dead-time after the conductive period; receive a duty cycle command; determine an adjusted duty cycle representing the conductive period as a portion of an operating period of the plurality of operating periods; determine a duty cycle difference signal as a difference between an initial duty cycle and the adjusted duty cycle, wherein the initial duty cycle is based on the duty cycle command; and determine a feedback duty offset signal based on the duty cycle difference signal. Determining the adjusted duty cycle includes the controller computing the adjusted duty cycle based on the feedback duty offset signal.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows a schematic diagram of an electric power steering (EPS) system according to the principles of the present disclosure.

FIG. 2 presents a block diagram of a brushless DC (BLDC) motor drive system according to the principles of the present disclosure.

FIG. 3 shows a schematic diagram of a motor drive system for operating a brushless direct current (BLDC) motor, according to the principles of the present disclosure.

FIG. 4 shows a graph illustrating pulse-width modulation (PWM) operation of switches in the inverter of FIG. 3 and showing ideal operation (without dead-time) and actual operation (with dead-time).

FIG. 5 shows a schematic block diagram of a BLDC controller for operating a phase driver in a BLDC motor drive system, according to the principles of the present disclosure.

FIG. 6 shows a schematic block diagram of a prefeed signal generator of the controller of FIG. 5, according to the principles of the present disclosure.

FIG. 7 shows a schematic block diagram of feedback signal generator for dead-time compensation in a BLDC controller, according to the principles of the present disclosure.

FIG. 8A shows a graph of d-axis current and q-axis current of a BLDC motor and with no dead-time compensation.

FIG. 8B shows a graph of d-axis current and q-axis current of a BLDC motor and with only prefeed dead-time compensation.

FIG. 8C shows a graph of d-axis current and q-axis current of a BLDC motor and with only backfeed dead-time compensation.

FIG. 8D shows a graph of d-axis current and q-axis current of a BLDC motor and with both prefeed dead-time compensation and feedback dead-time compensation.

FIGS. 9A-9B show a flow diagram listing steps in a method of operating an inverter for a BLDC motor, according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

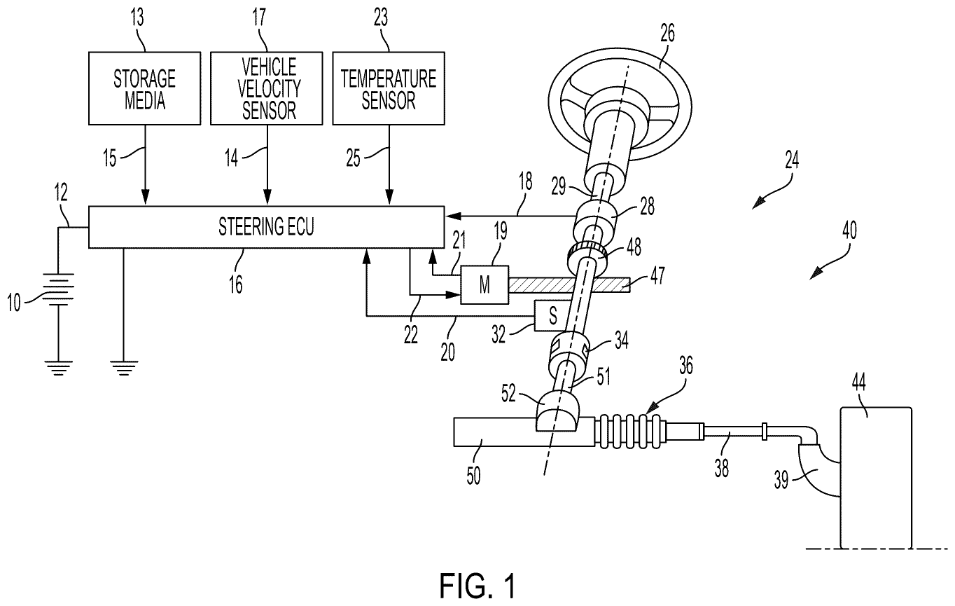

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system 24 and includes a steering electronic control unit (ECU) 16 and an electric motor 19. The steering ECU 16 is powered by the vehicle power supply 10 through supply conductors 12. The steering ECU 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the steering ECU 16 a position signal 20. Motor velocity may be measured with a tachometer, or any other device, and transmitted to the steering ECU 16 as a velocity signal 21. A motor velocity denoted wm may be measured, calculated or a combination thereof. For example, the motor velocity wm may be calculated as the change of the motor position as measured by a position sensor 32 over a prescribed time interval. For example, motor speed wm may be determined as the derivative of the motor position Om with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to the steering ECU 16 in relation to the amount of twist on the torsion bar. Although this is one type of torque sensor, any other suitable torque-sensing device used with known signal processing techniques will suffice. In response to the various inputs, the controller sends a command 22 to the electric motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the steering ECU 16 utilizes the torque, position, and speed, and like, to compute a command(s) to deliver the required output power. The steering ECU 16 is disposed in communication with the various systems and sensors of the motor control system. Steering ECU 16 receives signals from each of the system sensors, quantifies the received information, and provides an output command signal(s) in response thereto, in this instance, for example, to the electric motor 19. Steering ECU 16 is configured to develop the corresponding voltage(s) out of inverter (not shown), which may optionally be incorporated with steering ECU 16 and will be referred to herein as steering ECU 16, such that, when applied to the electric motor 19, the desired torque or position is generated. In one or more examples, the steering ECU 16 operates in a feedback control mode, as a current regulator, to generate the command 22. Alternatively, in one or more examples, the steering ECU 16 operates in a feedforward control mode to generate the command 22. Because these voltages are related to the position and speed of the electric motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the electric motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the electric motor 19. Preferably, the temperature sensor 23 is configured to directly measure the temperature of the sensing portion of the electric motor 19. The temperature sensor 23 transmits a temperature signal 25 to the steering ECU 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the steering ECU 16. The steering ECU 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), steering ECU 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, steering ECU 16 may include input signal processing and filtering to enable accurate sampling and conversion or acquisitions of such signals from communications interfaces.

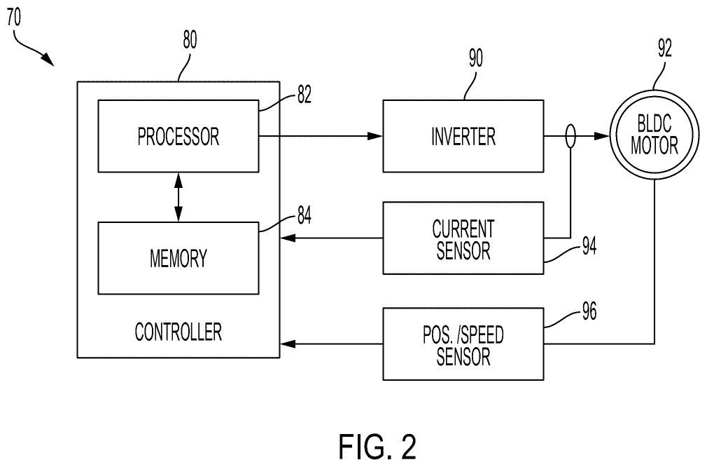

FIG. 2 is a block diagram of a brushless DC (BLDC) motor drive system 70 according to the principles of the present disclosure. The motor drive system 70 includes a BLDC motor 92, which may be a multi-phase machine having multiple sets of stator windings, each configured to conduct a DC current and to generate a torque. For example, the BLDC motor 92 may be a three-phase device having three sets of stator windings. However, the brushless DC motor 92 may have a different number of sets of stator windings. The BLDC motor 92 may be used as the electric motor 19 in the steering motion control system 24. Alternatively or additionally, the BLDC motor 92 may be used in another application.

The motor drive system 70 includes a controller 80, such as an electronic control unit (ECU). The controller 80 may implement one or more functions of the steering ECU 16. controller 80 may be configured to control, for example, the various functions of the steering system and/or various functions of a vehicle. The controller 80 may include a processor 82 and a memory 84. The processor 82 may include any suitable processor, such as those described herein. Additionally, or alternatively, the controller 80 may include any suitable number of processors, in addition to or other than the processor 82. The memory 84 may comprise a single disk, a plurality of disks (e.g., hard drives) and/or an electronic non-volatile computer memory storage medium such as a Flash memory device. In some embodiments, memory 84 may include flash memory, semiconductor (solid state) memory or the like. The memory 84 may include Random Access Memory (RAM), a Read-Only Memory (ROM), or a combination thereof. The memory 84 may include instructions that, when executed by the processor 82, cause the processor 82 to, at least, control various aspects of the vehicle. Additionally, or alternatively, the memory 84 may include instructions that, when executed by the processor 82, cause the processor 82 to perform functions associated with the systems and methods described herein.

The controller 80 may be operably connected to an inverter 90. The inverter 90 may be configured to apply a DC output voltage V_{OUT} on one or more terminals connected to stator windings of the BLDC motor 92. The inverter 90 may generate the DC output voltage V_{OUT} based on a duty cycle command Duty_Cmd from the controller 80.

In some embodiments, and as shown in FIG. 2, the motor drive system 70 may include a current sensor 94 configured to measure the current supplied to the BLDC motor 92 and to transmit a motor current signal to the controller 80, representing an actual motor current in a winding of the BLDC motor 92. Additionally or alternatively, and as also shown in FIG. 2, the motor drive system 70 may include one or more position sensors 96 and configured to measure a rotational position of the BLDC motor 92 and to transmit a motor position signal Om to the controller 80.

In some embodiments, the controller 80 may perform the methods described herein. However, the methods described herein as performed by the controller 80 are not meant to be limiting, and any type of software executed on a controller or processor can perform the methods described herein without departing from the scope of this disclosure. For example, a controller, such as a processor executing software within a computing device, can perform the methods described herein.

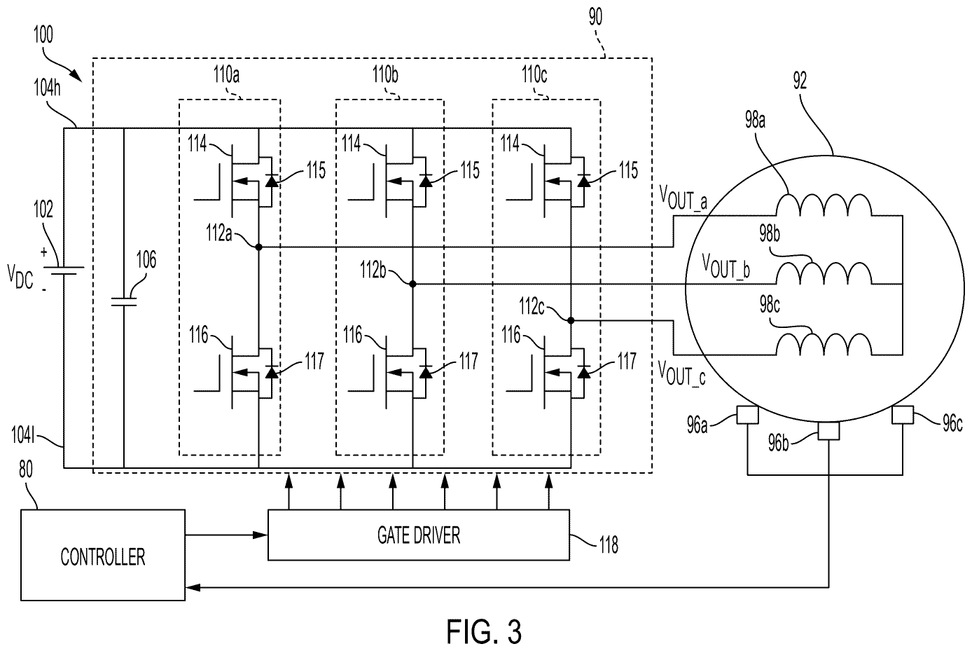

FIG. 3 shows a schematic diagram of a motor drive system 100 for operating a brushless direct current (BLDC) motor 92. The motor drive system 100 includes a DC power supply 102 having a DC high node 104h and a DC low node 104l and having a DC voltage VDC therebetween. The DC power supply 102 is illustrated as a battery. However, the DC power supply 102 may have a different configuration, such as a DC/DC converter and/or a rectifier to provide the DC power from an AC source.

The motor drive system 100 also includes the inverter 90 having an input capacitor 106 connected between the DC high node 104h and the DC low node 104l for regulating voltage thereacross. The inverter 90 also includes three phase drivers 110a, 110b, 110c. Each of the three phase drivers 110a, 110b, 110c receives the DC power from the DC power supply 102 and supplies output power to the BLDC motor 92 via a corresponding one of three output nodes 112a, 112b, 112c.

The three phase drivers 110a, 110b, 110c include an a-phase driver that generates a first DC power having an a-phase output voltage V_{OUT_a} on an a-phase output node 112a of the three output nodes 112a, 112b, 112c. The three phase drivers 110a, 110b, 110c also include a b-phase driver that generates a second DC power having a b-phase output voltage V_{OUT_b} on a b-phase output node 112b of the three output nodes 112a, 112b, 112c. The three phase drivers 110a, 110b, 110c also include a c-phase driver that generates a third DC power having a c-phase output voltage V_{OUT_c} on a c-phase output node 112c of the three output nodes 112a, 112b, 112c. Each of the three output nodes 112a, 112b, 112c is connected to a corresponding stator winding 98a, 98b, 98c of the BLDC motor 92. The BLDC motor 92 is shown as a three-phase device having three of the stator windings 98a, 98b, 98c with a wye connection. However, the BLDC motor 92 may have a different configuration, such as a delta connection of the stator windings 98a, 98b, 98c and/or a different number of the stator windings 98a, 98b, 98c.

Each of the three phase drivers 110a, 110b, 110c includes a high-side switch 114 configured to selectively conduct current between the DC high node 104h and a corresponding one of the three output nodes 112a, 112b, 112c. The high-side switches 114 may each include a metal-oxide-semiconductor field-effect transistor (MOSFET). However, other types of switching devices may be used, such as an insulated-gate bipolar transistor (IGBT) or another type of field-effect transistor (FET), such as a Gallium Nitride High-Electron-Mobility Transistor (GaN HEMT) or a Silicon Carbide High-Electron-Mobility Transistor (SIC HEMT). A high-side body diode 115 is connected across each of the high-side switches 114. The high-side body diode 115 defines a cathode that is connected to the DC high node 104h, and an anode that is connected to the corresponding one of the three output nodes 112a, 112b, 112c. The high-side body diode 115 may be a stand-alone device. Alternatively, the high-side body diode 115 may represent a functional effect of the associated high-side switch 114 that is connected thereacross.

Each of the three phase drivers 110a, 110b, 110c also includes a low-side switch 116 configured to selectively conduct current between the DC low node 104l and a corresponding one of the three output nodes 112a, 112b, 112c. The low-side switches 116 may each include a metal-oxide-semiconductor field-effect transistor (MOSFET). However, other types of switching devices may be used, such as an insulated-gate bipolar transistor (IGBT) or another type of field-effect transistor (FET), such as a Gallium Nitride High-Electron-Mobility Transistor (GaN HEMT) or a Silicon Carbide High-Electron-Mobility Transistor (SIC HEMT). A low-side body diode 117 is connected across each of the low-side switches 116. The low-side body diode 117 defines a cathode that is connected to the corresponding one of the three output nodes 112a, 112b, 112c, and an anode that is connected to the DC low node 104l. The low-side body diode 117 may be a stand-alone device. Alternatively, the low-side body diode 117 may represent a functional effect of the associated low-side switch 116 that is connected thereacross.

The motor drive system 100 also includes three position sensors 96a, 96b, 96c of the one or more position sensors 96 and which are functionally connected to the controller 80 to enable the controller 80 to detect a rotational position of the BLDC motor 92. The three position sensors 96a, 96b, 96c may include Hall-effect sensors configured to measure a rotor position of the BLDC motor 92. However, the three position sensors 96a, 96b, 96c may use another type of sensing technique.

The motor drive system 100 also includes a gate driver 118 that is configured to generate control signals for commanding operation of each of the high-side switches 114 and each of the low-side switches 116. For example, the gate driver 118 may generate pulse-width modulated (PWM) control signals for application to the gates of the high-side switches 114 and the low-side switches 116 to command each of the switches 114, 116 to selectively conduct current.

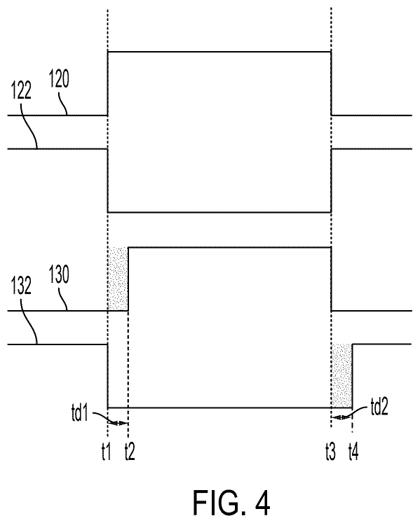

FIG. 4 shows a graph illustrating pulse-width modulation (PWM) operation of switches in one of the three phase drivers 110a, 110b, 110c of the inverter 90. FIG. 4 includes a first plot 120 showing ideal operation of the high-side switch 114, and a second plot 122 showing ideal operation of the low-side switch 116. At a first time t1, the high-side switch 114 transitions from a non-conductive state to a conductive state, shown by the first plot 120 stepping-up from a low (de-asserted) level to a high (asserted) level. At the same first time t1, the low-side switch 116 transitions from a conductive state to a non-conductive state, shown by the second plot 122 stepping-down from a high (asserted) level to a low (de-asserted) level. At a third time t3, after the first time t1, the high-side switch 114 transitions from the conductive state to the non-conductive state, shown by the first plot 120 stepping-down from the high (asserted) level to the low (de-asserted) level. At the same third time t3, the low-side switch 116 transitions from the non-conductive state to the conductive state, shown by the second plot 122 stepping-up from the low (de-asserted) level to the high (asserted) level.

However, because of real-world considerations, such as non-ideal switching and imprecise timing, simultaneous switching of the high-side switch 114 and the low-side switch 116 can cause the DC power supply 102 to be short circuited by the high-side switch 114 and the low-side switch 116 being simultaneously in the conductive state. Thus, a dead-time is used in actual operation to prevent such simultaneous conduction by the high-side switch 114 and the low-side switch 116.

FIG. 4 includes a third plot 130 showing actual operation of the high-side switch 114, and a fourth plot 132 showing actual operation of the low-side switch 116. As shown, on the third plot 130, the high-side switch 114 transitions from the non-conductive state to the conductive state, shown by the third plot 130 stepping-up from the low (de-asserted) level to the high (asserted) level, at a second time t2 that is after the first time t1. The time difference between the first time t1 and the second time t2 is known as a first dead-time td1. During the first dead-time td1, both of the high-side switch 114 and the low-side switch 116 are in the non-conductive state.

Additionally, and as shown by the third plot 130, the high-side switch 114 transitions from the conductive state to the non-conductive state, shown by the third plot 130 stepping-down from the high (asserted) level to the low (de-asserted) level at a third time t3 that is before the fourth time t4. The time difference between the third time t3 and the fourth time t4 is known as a second dead-time td2. During the second dead-time td2, both of the high-side switch 114 and the low-side switch 116 are in the non-conductive state. The second dead-time td2 may be equal in duration to the first dead-time td1. However, the second dead-time td2 between the third time t3 and the fourth time t4 may have a duration that is different from the first dead-time td1 between the first time t1 and the second time t2.

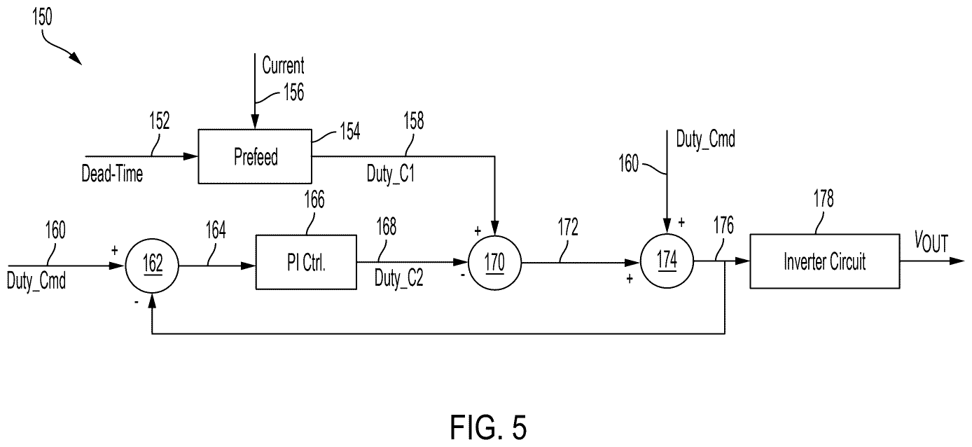

FIG. 5 shows a schematic block diagram of a BLDC controller 150 for operating a phase driver in a BLDC motor drive system, according to the principles of the present disclosure. The BLDC controller 150 may be implemented in hardware and/or in software. For example, the processor 82 may execute instructions to implement some or all of the features of the BLDC controller 150.

The BLDC controller 150 takes a duty cycle command 160 as an input. The duty cycle command 160 may represent a percentage of time that one of the three phase drivers 110a, 110b, 110c of the inverter 90 is to be operated with its respective high-side switch 114 in the conductive state in each of a plurality of operating periods. Thus, the duty cycle command 160 may control an output voltage V_{OUT} to be generated by the corresponding one of the three phase drivers 110a, 110b, 110c. However, and because of effects of the dead-times td1, td2, changes to the duty cycle command 160 may have non-linear effect on the output voltage V_{OUT}. The techniques of the present disclosure may compensate for such non-linear effects so the output voltage V_{OUT} can be more effectively and efficiently controlled. The output voltage V_{OUT} may represent the a-phase output voltage V_{OUT_a}, the b-phase output voltage V_{OUT_b}, and/or the c-phase output voltage V_{OUT_c} that is generated on one of three output nodes 112a, 112b, 112c by a corresponding one of the three phase drivers 110a, 110b, 110c.

The BLDC controller 150 receives a dead-time signal 152 representing a dead-time td, such as the first dead-time td1 and/or the second dead-time dt2. Alternatively, the dead-time signal 152 may represent an average of the first dead-time td1 and the second dead-time dt2. The BLDC controller 150 also receives a current signal 156 representing the current supplied by the corresponding one of the three phase drivers 110a, 110b, 110c and to the BLDC motor 92 via the corresponding one of the three phase drivers 110a, 110b, 110c. The BLDC controller 150 includes a prefeed signal generator 154 that generates a prefeed duty offset signal 158, also called also called Duty_C1, based on the dead-time signal 152 and based on the current signal 156.

The BLDC controller 150 also includes a first subtractor 162 that is configured to generate a duty cycle difference signal 164, which may also be called an error signal Err, as a difference between an initial duty cycle and an adjusted duty cycle 176. In some embodiments, and as shown in FIG. 5 the initial duty cycle is the duty cycle command 160, and the first subtractor generates the duty cycle difference signal 164 by subtracting the adjusted duty cycle 176 from the duty cycle command 160.

The BLDC controller 150 also includes a proportional-integral controller 166 that computes a feedback duty offset signal 168, also called Duty_C2, based on the duty cycle difference signal 164. The BLDC controller 150 also includes a second subtractor 170 that subtracts the feedback duty offset signal 168 from the prefeed duty offset signal 158 to calculate a final duty cycle offset signal 172. The BLDC controller 150 also includes an adder 174 that computes the adjusted duty cycle 176 by adding the final duty cycle offset signal 172 to the duty cycle command 160.

The BLDC controller 150 also includes an inverter circuit 178 that generates the DC output voltage V_{OUT} based on the adjusted duty cycle 176. The inverter circuit 178 may represent one of the three phase drivers 110a, 110b, 110c and a corresponding driver circuitry, such as portions of the gate driver 118 and/or other devices to coordinate timing of operating the switches 114, 116 within the one of the three phase drivers 110a, 110b, 110c.

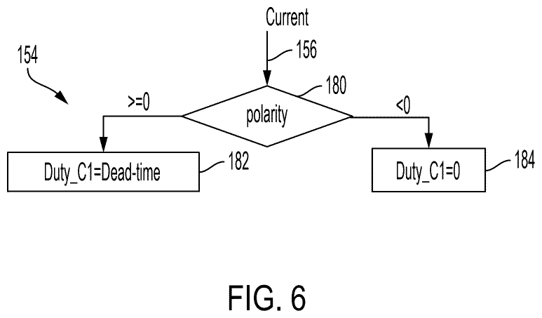

FIG. 6 shows a schematic block diagram of a prefeed signal generator 154 of the controller of FIG. 5. As shown, the prefeed signal generator 154 includes a polarity evaluator 180 that receives the current signal 156 and determines if the polarity of the current between the output node and the BLDC motor is non-negative. The prefeed signal generator 154 includes a first assignor 182 that sets the prefeed duty offset signal 158 based on the dead-time signal 152 in response to the polarity evaluator 180 determining the current between the output node and the BLDC motor being non-negative. More specifically, the first assignor 182 may set the prefeed duty offset signal 158 equal to the dead-time signal 152 in response to the polarity evaluator 180 determining the current between the output node and the BLDC motor being non-negative. The prefeed signal generator 154 also includes a second assignor 184 that sets the prefeed duty offset signal 158 equal to zero in response to the polarity evaluator 180 determining the current between the output node and the BLDC motor being negative.

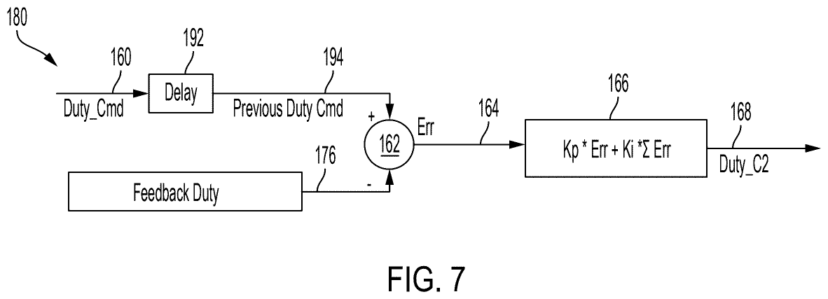

FIG. 7 shows a schematic block diagram of a feedback signal generator 190 for dead-time compensation in a BLDC controller, according to an aspect of the present disclosure. The feedback signal generator 190 may modify portions of the BLDC controller 150. The feedback signal generator 190 includes a delay element 192 that receives the duty cycle command 160 and outputs a previous duty command 194 representing the duty cycle command 160 at an earlier time. The feedback signal generator 190 uses the previous duty command 194 as the initial duty cycle, instead of the duty cycle command 160. FIG. 7 also shows details of the proportional-integral controller 166 that computes a feedback duty offset signal 168 in accordance with an equation: Duty_C2=Kₚ*Err+Kᵢ*Σ Err, where Kₚ is a proportional tuning constant and Kᵢ is a proportional tuning constant.

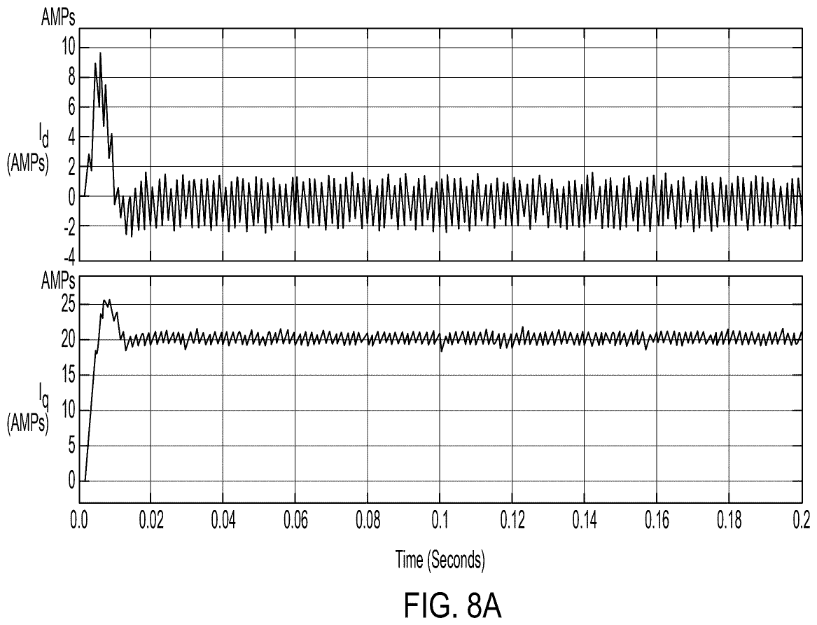

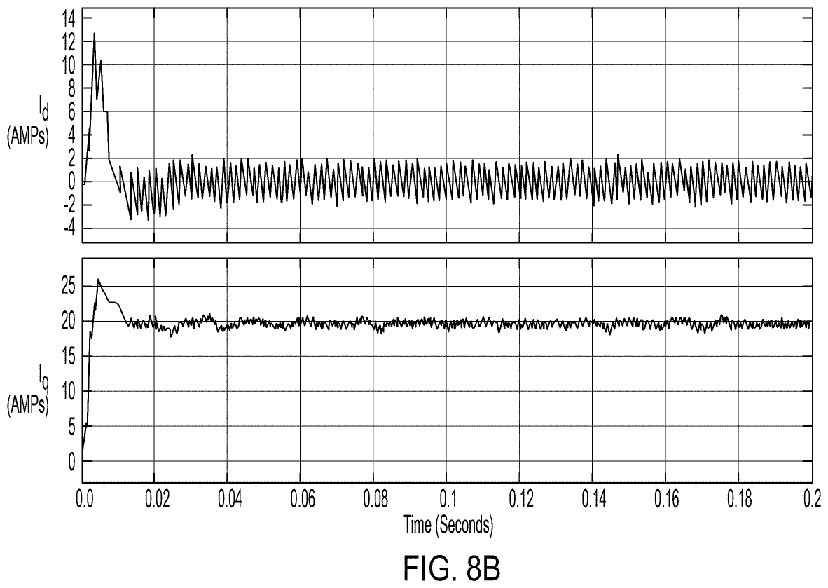

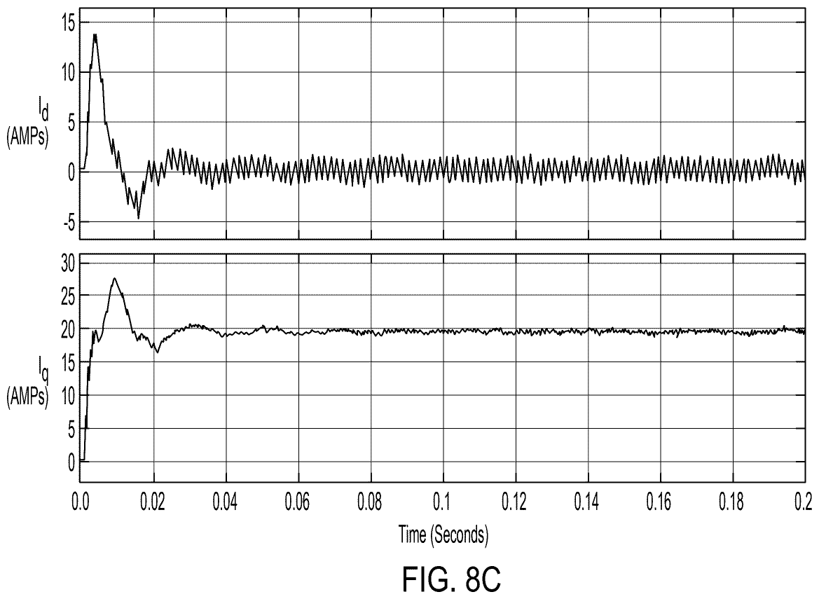

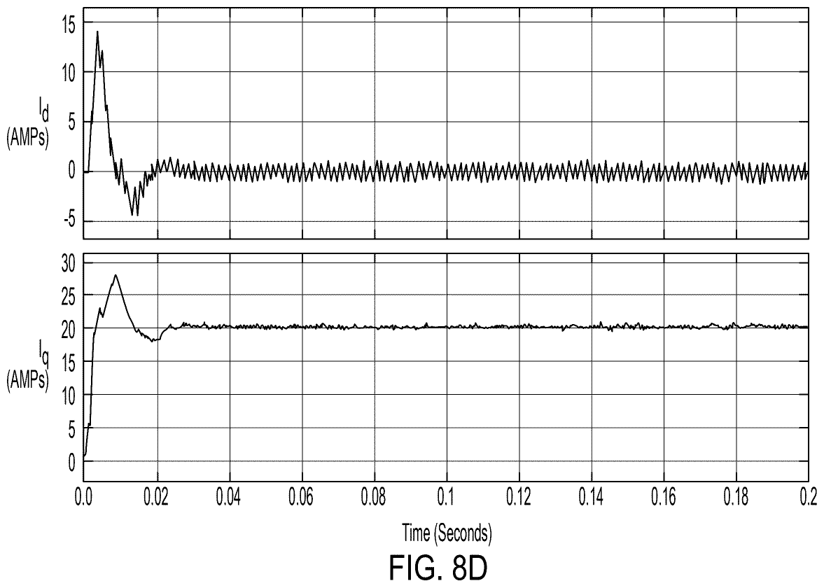

FIG. 8A shows a graph of d-axis current and q-axis current of a BLDC motor and with no dead-time compensation. FIG. 8B shows a graph of d-axis current and q-axis current of a BLDC motor and with only prefeed dead-time compensation. FIG. 8C shows a graph of d-axis current and q-axis current of a BLDC motor and with only backfeed dead-time compensation. FIG. 8D shows a graph of d-axis current and q-axis current of a BLDC motor and with both prefeed dead-time compensation and feedback dead-time compensation. Table 1, below, shows effects of prefeed compensation, feedback compensation, and a combination of prefeed and feedback compensation, on d-axis and q-axis current ripple. Prefeed compensation refers to using the prefeed duty offset signal 158 for determining the adjusted duty cycle 176 that is used to control the inverter circuits 178, and feedback compensation refers to using the feedback duty offset signal 168 for determining the adjusted duty cycle 176 that is used to control the inverter circuits 178. As shown, the combination of prefeed and feedback compensation provides the greatest reduction in current ripple. This reduction in current ripple can have several advantageous results, such as improvements in efficiency and/or a reduction in noise and vibration produced by the BLDC motor 92 and/or the inverter 90.

TABLE 1

| Current Ripple | d-axis current (Amps) | q-axis current (Amps) |
|---|---|---|
| No Compensation | ±2.1 | ±1.5 |
| Prefeed Compensation | ±2.0 | ±1.2 |
| Feedback Compensation | ±1.8 | ±1.0 |
| Prefeed and Feedback | ±1.4 | ±0.8 A |
| Compensation | | |

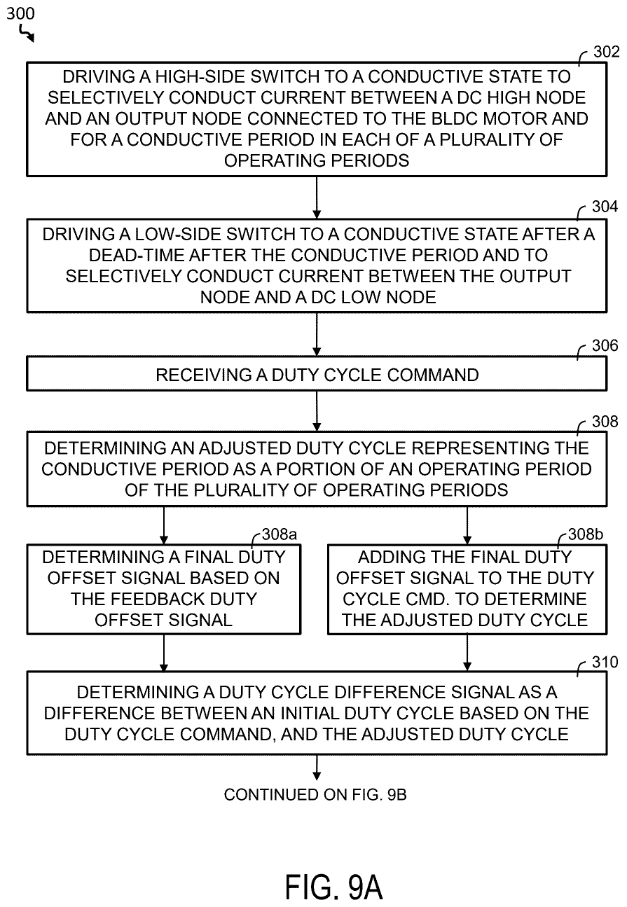

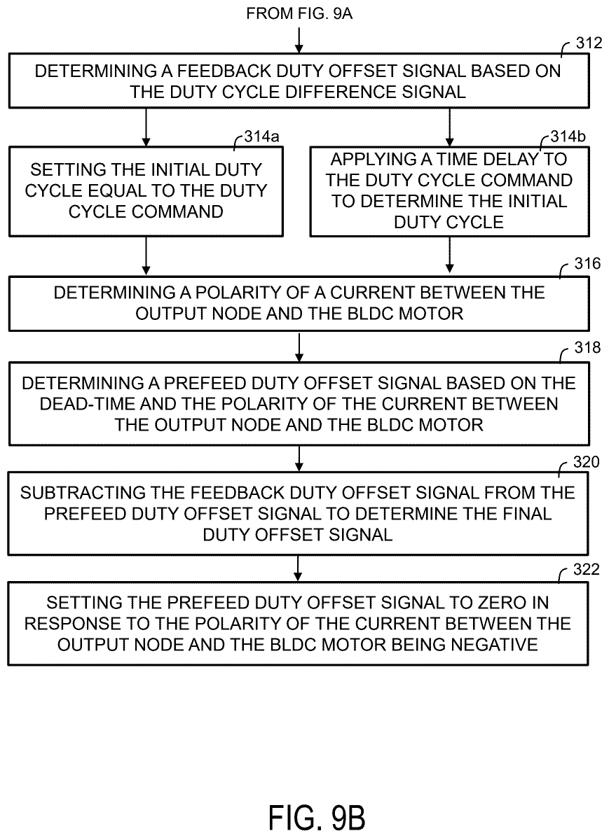

FIGS. 9A-9B show a flow diagram listing steps in a method 300 of operating an inverter for a BLDC motor, according to the principles of the present disclosure. The method 300 can be performed by the controller 80 of the present disclosure. As can be appreciated in light of the disclosure, the order of operation within the method is not limited to the sequential execution as illustrated in FIGS. 9A-9B, but may be performed in one or more varying orders as applicable and in accordance with the present disclosure.

The method 300 includes, at 302, driving a high-side switch to a conductive state to selectively conduct current between a DC high node and an output node connected to the BLDC motor and for a conductive period in each of a plurality of operating periods. For example, the processor 82 may execute instructions to command the gate driver 118 to cause a corresponding one of the high-side switches 114 to selectively conduct current between the DC high node 104h and a corresponding one of the three output nodes 112a, 112b, 112c and for a conductive period, such as the duration between the second time t2 and the third time t3, as shown in the third plot 130 of FIG. 4. In some embodiments, and as shown in FIG. 4, step 302 may include driving the one of the high-side switches 114 to the conductive state only after a first deadtime td1 after a corresponding one of the low-side switches 116 is switched to the non-conductive state.

The method 300 also includes, at 304, driving a low-side switch to a conductive state after a dead-time after the conductive period to selectively conduct current between the output node and a DC low node. The DC low node and the DC high node have a DC voltage applied therebetween. For example, the processor 82 may execute instructions to command the gate driver 118 to cause a corresponding one of the low-side switches 116 to selectively conduct current between the DC low node 104l and the corresponding one of the three output nodes 112a, 112b, 112c after a deadtime after the conductive period has ended. As shown in the fourth plot 132 of FIG. 4, the low-side switch 116 is driven to its conductive state at the fourth time t4, which is after the third time t3 after the conductive period (i.e. when the high-side switch 114 in a same one of the three phase drivers 110a, 110b, 110c is in the conductive state). Furthermore and as also shown on FIG. 4, the duration between the third time t3, when the high-side switch 114 is driven to a non-conductive state and the fourth time t4, when the corresponding low-side switch 116 is driven to its conductive state, is equal to the second dead time td2.

The method 300 also includes, at 306, receiving a duty cycle command. For example, the processor 82 may execute instructions to implement the motor drive system 100, which receives the duty cycle command 160. The duty cycle command 160 may be received from another functional unit, such as a motion controller that may generate the duty cycle command 160 to cause the BLDC motor 92 to generate a given amount of torque and/or to operate at a given speed. The source of the duty cycle command 160 may be internal, such as another software module executed by the processor 82. Alternatively, the duty cycle command 160 may be received from an external source, such as a separate hardware device.

The method 300 also includes, at 308, determining an adjusted duty cycle representing the conductive period as a portion of an operating period of the plurality of operating periods. For example, the processor 82 may execute instructions to implement the adder 174 that computes the adjusted duty cycle 176 by adding a final duty cycle offset signal 172 to the duty cycle command 160. Additionally, the adjusted duty cycle 176 may be supplied to the inverter circuit 100 and thereby used to control the duration of time of the conductive period (i.e. how long step 302 functions to maintain the high-side switch in the conductive state in a given operating period of the plurality of operating periods).

In some embodiments, step 308 further includes: determining, at 308a, a final duty offset signal based on the feedback duty offset signal; and adding, at 308b, the final duty offset signal to the duty cycle command to determine the adjusted duty cycle. For example, the processor 82 may execute instructions to perform 308a by implementing the second subtractor 170 to subtract the feedback duty offset signal 168 from another signal, such as the prefeed duty offset signal 158, and to thereby calculate the final duty cycle offset signal 172. Additionally, the processor 82 may execute instructions to perform 308b by implementing the adder 174 to compute the adjusted duty cycle 176 by adding a final duty cycle offset signal 172 to the duty cycle command 160.

The method 300 also includes, at 310, determining a duty cycle difference signal as a difference between an initial duty cycle based on the duty cycle command, and the adjusted duty cycle. For example, the processor 82 may execute instructions to implement the first subtractor 162 to generate the duty cycle difference signal 164 as a difference between an initial duty cycle and the adjusted duty cycle 176.

The method 300 also includes, at 312, determining a feedback duty offset signal based on the duty cycle difference signal. For example, the processor 82 may execute instructions to implement the proportional-integral controller 166 that computes the feedback duty offset signal 168 based on the duty cycle difference signal 164.

Determining the adjusted duty cycle at step 308 includes computing the adjusted duty cycle based on the feedback duty offset signal. For example, the processor 82 may execute instructions to implement the second subtractor 170 that subtracts the feedback duty offset signal 168 from another signal (such as the prefeed duty offset signal 158) to calculate the final duty cycle offset signal 172.

In some embodiments, the inverter includes a plurality of phase drivers each configured to supply a corresponding DC power to the BLDC motor via a corresponding output node. For example, the method 300 may be repeated for each of the three phase drivers 110a, 110b, 110c of the inverter 90 for supplying power to three separate stator windings 98a, 98b, 98c of the BLDC motor 92.

In some embodiments, the method 300 includes setting, at 314a, the initial duty cycle equal to the duty cycle command. For example, and as shown in FIG. 5, the first subtractor 162 may compute the duty cycle difference signal 164 by subtracting the adjusted duty cycle 176 from the duty cycle command 160.

Alternatively, the method 300 may include, at 314b, determining the initial duty cycle by applying a time delay to the duty cycle command. For example, the processor 82 may execute instructions to implement the delay element 192 to generate the previous duty command 194 representing the duty cycle command 160 at an earlier time, and as shown on FIG. 9, the feedback signal generator 190 may use the previous duty command 194 as the initial duty cycle.

The method 300 also includes, at 316, determining a polarity of a current between the output node and the BLDC motor. For example, the processor 82 may execute instructions to implement the polarity evaluator 180 to determine if the polarity of the current between the output node and the BLDC motor is non-negative.

The method 300 also includes, at 318, determining a prefeed duty offset signal based on the dead-time and the polarity of the current between the output node and the BLDC motor. For example, the processor 82 may execute instructions to implement the first assignor 182 to set the prefeed duty offset signal 158 equal to the dead-time signal 152 in response to the polarity evaluator 180 determining the current between the output node and the BLDC motor being non-negative.

The method 300 also includes, at 320, subtracting the feedback duty offset signal from the prefeed duty offset signal to determine the final duty offset signal. For example, the processor 82 may execute instructions to implement the second subtractor 170 to subtract the feedback duty offset signal 168 from the prefeed duty offset signal 158 to calculate a final duty cycle offset signal 172.

The method 300 also includes setting, at 322, the prefeed duty offset signal to zero in response to the polarity of the current between the output node and the BLDC motor being negative. For example, the processor 82 may execute instructions to implement the second assignor 184 that sets the prefeed duty offset signal 158 equal to zero in response to the polarity evaluator 180 determining the current between the output node and the BLDC motor being negative.

The present disclosure provides a method of operating an inverter for a brushless direct current (BLDC) motor. The method includes: driving a high-side switch to a conductive state to selectively conduct current between a DC high node and an output node connected to the BLDC motor and for a conductive period in each of a plurality of operating periods; driving a low-side switch to a conductive state after a dead-time after the conductive period to selectively conduct current between the output node and a DC low node, wherein the DC low node and the DC high node have a DC voltage applied therebetween; receiving a duty cycle command; determining an adjusted duty cycle representing the conductive period as a portion of an operating period of the plurality of operating periods; determining a duty cycle difference signal as a difference between an initial duty cycle and the adjusted duty cycle, wherein the initial duty cycle is based on the duty cycle command; and determining a feedback duty offset signal based on the duty cycle difference signal. Determining the adjusted duty cycle includes computing the adjusted duty cycle based on the feedback duty offset signal.

In some embodiments, the inverter includes a plurality of phase drivers each configured to supply a corresponding DC power to the BLDC motor via a corresponding output node.

In some embodiments, the initial duty cycle is equal to the duty cycle command.

In some embodiments, the method further includes determining the initial duty cycle by applying a time delay to the duty cycle command.

In some embodiments, determining the feedback duty offset signal further includes computing the feedback duty offset signal by a proportional-integral (PI) controller and based on the duty cycle difference signal.

In some embodiments, determining the adjusted duty cycle based on the feedback duty offset signal further includes: determining a final duty offset signal based on the feedback duty offset signal; and adding the final duty offset signal to the duty cycle command to determine the adjusted duty cycle.

In some embodiments, determining the final duty offset signal based on the feedback duty offset signal further includes: determining a polarity of a current between the output node and the BLDC motor; determining a prefeed duty offset signal based on the dead-time and the polarity of the current between the output node and the BLDC motor; and subtracting the feedback duty offset signal from the prefeed duty offset signal to determine the final duty offset signal.

In some embodiments, determining the prefeed duty offset signal based on the dead-time and the polarity of the current between the output node and the BLDC motor further includes: determining if the polarity of the current between the output node and the BLDC motor is non-negative; setting the prefeed duty offset signal based on the dead-time in response to the polarity of the current between the output node and the BLDC motor being non-negative; and setting the prefeed duty offset signal to zero in response to the polarity of the current between the output node and the BLDC motor being negative.

In some embodiments, the BLDC motor is configured to perform at least one of: applying an assist torque to a steering system of a vehicle, or controlling the steering system.

The present disclosure also provides a method of operating an inverter for a brushless direct current (BLDC) motor. The method includes: driving a high-side switch to a conductive state to selectively conduct current between a DC high node and an output node connected to the BLDC motor and for a conductive period in each of a plurality of operating periods; driving a low-side switch to a conductive state after a dead-time after the conductive period to selectively conduct current between the output node and a DC low node, wherein the DC low node and the DC high node have a DC voltage applied therebetween; receiving a duty cycle command; determining a current between the output node and the BLDC motor; determining a prefeed duty offset signal based on the current between the output node and the BLDC motor; determining an adjusted duty cycle based on the prefeed duty offset signal and the duty cycle command; and determining the conductive period based on the adjusted duty cycle and a duration of an operating period of the plurality of operating periods.

In some embodiments, the inverter includes a plurality of phase drivers each configured to supply a corresponding DC power to the BLDC motor via a corresponding output node.

In some embodiments, determining the prefeed duty offset signal further includes: determining a polarity of the current between the output node and the BLDC motor; and determining the prefeed duty offset signal based on the dead-time and the polarity of the current between the output node and the BLDC motor.

In some embodiments, determining the prefeed duty offset signal further includes: determining if the polarity of the current between the output node and the BLDC motor is non-negative; setting the prefeed duty offset signal based on the dead-time in response to the polarity of the current between the output node and the BLDC motor being non-negative; and setting the prefeed duty offset signal to zero in response to the polarity of the current between the output node and the BLDC motor being negative.

In some embodiments, the method further includes: determining a feedback duty cycle based on an on-time of the conductive period divided by a total time of a corresponding operating period of the plurality of operating periods; determining a duty cycle difference signal as a difference between an initial duty cycle and the feedback duty cycle, wherein the initial duty cycle is based on the duty cycle command; and determining a feedback duty offset signal based on the duty cycle difference signal. Determining the adjusted duty cycle based on the prefeed duty offset signal and the duty cycle command may include determining the adjusted duty cycle further based on the feedback duty offset signal.

In some embodiments, determining the feedback duty offset signal further includes computing the feedback duty offset signal by a proportional-integral (PI) controller and based on the duty cycle difference signal.

In some embodiments, determining the adjusted duty cycle based on the prefeed duty offset signal and the duty cycle command further includes: subtracting the feedback duty offset signal from the prefeed duty offset signal to determine a final duty offset signal; and adding the final duty offset signal to the duty cycle command to determine the adjusted duty cycle.

The present disclosure also provides a system for operating a brushless direct current (BLDC) motor. The system includes: a DC power supply including a DC high node and a DC low node, wherein the DC low node and the DC high node have a DC voltage therebetween; an inverter having a phase driver configured to apply a DC power to the BLDC motor via an output node connected to the BLDC motor; and a controller. The phase driver includes: a high-side switch configured to selectively conduct current between the DC high node and the output node, and a low-side switch configured to selectively conduct current between the output node and the DC low node. The controller is configured to: drive the high-side switch to a conductive state for a conductive period in each of a plurality of operating periods; drive the low-side switch to a conductive state after a dead-time after the conductive period; receive a duty cycle command; determine an adjusted duty cycle representing the conductive period as a portion of an operating period of the plurality of operating periods; determine a duty cycle difference signal as a difference between an initial duty cycle and the adjusted duty cycle, wherein the initial duty cycle is based on the duty cycle command; and determine a feedback duty offset signal based on the duty cycle difference signal. Determining the adjusted duty cycle includes the controller computing the adjusted duty cycle based on the feedback duty offset signal.

In some embodiments, the controller is further configured to: determine a final duty offset signal based on the feedback duty offset signal; and add the final duty offset signal to the duty cycle command to determine the adjusted duty cycle.

In some embodiments, the controller is further configured to: determine a polarity of a current between the output node and the BLDC motor; determine a prefeed duty offset signal based on the dead-time and the polarity of the current between the output node and the BLDC motor; and subtract the feedback duty offset signal from the prefeed duty offset signal to determine the final duty offset signal.

In some embodiments, the BLDC motor is configured to perform at least one of: applying an assist torque to a steering system of a vehicle, or controlling the steering system.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method of operating an inverter for a brushless direct current (BLDC) motor, comprising:
driving a high-side switch to a conductive state to selectively conduct current between a DC high node and an output node connected to the BLDC motor and for a conductive period in each of a plurality of operating periods;
driving a low-side switch to a conductive state after a dead-time after the conductive period to selectively conduct current between the output node and a DC low node, wherein the DC low node and the DC high node have a DC voltage applied therebetween;
receiving a duty cycle command;
determining an adjusted duty cycle representing the conductive period as a portion of an operating period of the plurality of operating periods;
determining a duty cycle difference signal as a difference between an initial duty cycle and the adjusted duty cycle, wherein the initial duty cycle is based on the duty cycle command; and
determining a feedback duty offset signal based on the duty cycle difference signal,
wherein determining the adjusted duty cycle includes computing the adjusted duty cycle based on the feedback duty offset signal.

2. The method of claim 1, wherein the inverter includes a plurality of phase drivers each configured to supply a corresponding DC power to the BLDC motor via a corresponding output node.

3. The method of claim 1, wherein the initial duty cycle is equal to the duty cycle command.

4. The method of claim 1, further including determining the initial duty cycle by applying a time delay to the duty cycle command.

5. The method of claim 1, wherein determining the feedback duty offset signal further includes computing the feedback duty offset signal by a proportional-integral (PI) controller and based on the duty cycle difference signal.

6. The method of claim 1, wherein determining the adjusted duty cycle based on the feedback duty offset signal further includes:
determining a final duty offset signal based on the feedback duty offset signal; and
adding the final duty offset signal to the duty cycle command to determine the adjusted duty cycle.

7. The method of claim 6, wherein determining the final duty offset signal based on the feedback duty offset signal further includes:
determining a polarity of a current between the output node and the BLDC motor;
determining a prefeed duty offset signal based on the dead-time and the polarity of the current between the output node and the BLDC motor; and
subtracting the feedback duty offset signal from the prefeed duty offset signal to determine the final duty offset signal.

8. The method of claim 7, wherein determining the prefeed duty offset signal based on the dead-time and the polarity of the current between the output node and the BLDC motor further includes:
determining if the polarity of the current between the output node and the BLDC motor is non-negative;
setting the prefeed duty offset signal based on the dead-time in response to the polarity of the current between the output node and the BLDC motor being non-negative; and
setting the prefeed duty offset signal to zero in response to the polarity of the current between the output node and the BLDC motor being negative.

9. The method of claim 1, wherein the BLDC motor is configured to perform at least one of: applying an assist torque to a steering system of a vehicle, or controlling the steering system.

10. A method of operating an inverter for a brushless direct current (BLDC) motor, comprising:
driving a high-side switch to a conductive state to selectively conduct current between a DC high node and an output node connected to the BLDC motor and for a conductive period in each of a plurality of operating periods;
driving a low-side switch to a conductive state after a dead-time after the conductive period to selectively conduct current between the output node and a DC low node, wherein the DC low node and the DC high node have a DC voltage applied therebetween;
receiving a duty cycle command;
determining a current between the output node and the BLDC motor;
determining a prefeed duty offset signal based on the current between the output node and the BLDC motor;
determining an adjusted duty cycle based on the prefeed duty offset signal and the duty cycle command; and
determining the conductive period based on the adjusted duty cycle and a duration of an operating period of the plurality of operating periods.

11. The method of claim 10, wherein the inverter includes a plurality of phase drivers each configured to supply a corresponding DC power to the BLDC motor via a corresponding output node.

12. The method of claim 10, wherein determining the prefeed duty offset signal further includes:
determining a polarity of the current between the output node and the BLDC motor; and
determining the prefeed duty offset signal based on the dead-time and the polarity of the current between the output node and the BLDC motor.

13. The method of claim 12, wherein determining the prefeed duty offset signal further includes:
determining if the polarity of the current between the output node and the BLDC motor is non-negative;
setting the prefeed duty offset signal based on the dead-time in response to the polarity of the current between the output node and the BLDC motor being non-negative; and
setting the prefeed duty offset signal to zero in response to the polarity of the current between the output node and the BLDC motor being negative.

14. The method of claim 10, further including:
determining a feedback duty cycle based on an on-time of the conductive period divided by a total time of a corresponding operating period of the plurality of operating periods;
determining a duty cycle difference signal as a difference between an initial duty cycle and the feedback duty cycle, wherein the initial duty cycle is based on the duty cycle command; and
determining a feedback duty offset signal based on the duty cycle difference signal,
wherein determining the adjusted duty cycle based on the prefeed duty offset signal and the duty cycle command includes determining the adjusted duty cycle further based on the feedback duty offset signal.

15. The method of claim 14, wherein determining the feedback duty offset signal further includes computing the feedback duty offset signal by a proportional-integral (PI) controller and based on the duty cycle difference signal.

16. The method of claim 14, wherein determining the adjusted duty cycle based on the prefeed duty offset signal and the duty cycle command further includes:
subtracting the feedback duty offset signal from the prefeed duty offset signal to determine a final duty offset signal; and
adding the final duty offset signal to the duty cycle command to determine the adjusted duty cycle.

17. A system for operating a brushless direct current (BLDC) motor, comprising:
a DC power supply including a DC high node and a DC low node, wherein the DC low node and the DC high node have a DC voltage therebetween;
an inverter having a phase driver configured to apply a DC power to the BLDC motor via an output node connected to the BLDC motor, wherein the phase driver includes: a high-side switch configured to selectively conduct current between the DC high node and the output node, and a low-side switch configured to selectively conduct current between the output node and the DC low node; and
a controller configured to:
drive the high-side switch to a conductive state for a conductive period in each of a plurality of operating periods;
drive the low-side switch to a conductive state after a dead-time after the conductive period;
receive a duty cycle command;
determine an adjusted duty cycle representing the conductive period as a portion of an operating period of the plurality of operating periods;
determine a duty cycle difference signal as a difference between an initial duty cycle and the adjusted duty cycle, wherein the initial duty cycle is based on the duty cycle command; and
determine a feedback duty offset signal based on the duty cycle difference signal,
wherein determining the adjusted duty cycle includes the controller computing the adjusted duty cycle based on the feedback duty offset signal.

18. The system of claim 17, wherein the controller is further configured to:
determine a final duty offset signal based on the feedback duty offset signal; and
add the final duty offset signal to the duty cycle command to determine the adjusted duty cycle.

19. The system of claim 18, wherein the controller is further configured to:
determine a polarity of a current between the output node and the BLDC motor;
determine a prefeed duty offset signal based on the dead-time and the polarity of the current between the output node and the BLDC motor; and
subtract the feedback duty offset signal from the prefeed duty offset signal to determine the final duty offset signal.

20. The system of claim 17, wherein the BLDC motor is configured to perform at least one of: applying an assist torque to a steering system of a vehicle, or controlling the steering system.
